(19) United States
(12) Patent Application Publication
(10) Pub. No.: US 2004/0096253 A1
(43) Pub. Date: May 20, 2004

(54) Sheet cutting apparatus, and sheet processing apparatus and image forming apparatus having the sheet cutting apparatus

(75) Inventors: Yuji Ueno, Ibaraki (JP); Hiroki Honmochi, Ibaraki (JP); Ken Yonekawa, Ibaraki (JP)

Correspondence Address: FITZPATRICK CELLA HARPER & SCINTO, 30 ROCKEFELLER PLAZA, NEW YORK, NY, 10112, US

(73) Assignee: CANON FINETECH INC., IBARAKI (JP)

(21) Appl. No.: 10/667,325

(22) Filed: Sep. 23, 2003

(30) Foreign Application Priority Data
Sep. 25, 2002 (JP) 2002-278915

(51) Int. Cl. G03G 15/00; B26D 7/06

(52) U.S. Cl. 399/385; 83/401

(57) ABSTRACT

The present invention relates to a sheet cutting apparatus comprising cutting means for cutting a sheet bundle, receiving means for receiving the cutting means, receiving position moving means for moving a receiving position on the receiving means for receiving the cutting means; and counting means for counting a number of cutting times of the sheet bundles. The receiving position moving means moves the receiving position on the receiving means according to information out of the counting means.

### BACKGROUND OF THE INVENTION

1. Field of the Invention

This invention relates to a sheet cutting apparatus for cutting a side surface of a sheet bundle upon forming the sheet bundle with a postprocessing apparatus from sheets such as photocopying sheets conveyed out of an image forming apparatus such as a photocopier, a printer, and a facsimile machine and to a sheet processing apparatus and an image forming apparatus, which are having the sheet cutting apparatus.

2. Description of Related Art

Conventionally known methods for cutting sheet bundles are mainly a pushingly cutting method for performing cutting in hitting a cutting blade as shown in FIG. 19(a) to a reception mat, see, e.g., Japanese Unexamined Patent Publication No. Heisei 10-225,893, and a shearing method for cutting sheet bundles by pressingly contacting two blades as shown in FIG. 19(b), see, e.g., Japanese Unexamined Patent Publication No. 2000-198,613. The reception mat in the cutting machine using the pushing cutting method is in a rectangular prism shape made of a material such as generally rubber urethane molded or the like, and has a duration of times of about 300 cuts per one surface. The reception conventionally increases the cut number four times, or namely 1200 cuts at four surfaces, by using the mat as rotating the surface at a position at which the cutting is received. The replacement of the mat exceeding the duration of times is done upon confirmation of the reception mat's state by the user.

There are various methods for processing sheet dusts when cut, and conventionally some processings are used, for example, in which a dust box absorbs the dusts by absorbing air, and in which a rectangular prism shaped reception mat supported rotatably to an arm is moved and further rotated to remove the dusts (see, e.g., Japanese Patent Unexamined Publication No. Heisei 06-170,788).

### SUMMARY OF THE INVENTION

A representative structure of the invention to accomplish the above objects is characterized in having: cutting means for cutting a sheet bundle; receiving means for receiving the cutting means; receiving position moving means for moving a receiving position on the receiving means for receiving the cutting means; and counting means for counting a number of cutting times of the sheet bundles, wherein the receiving position moving means moves the receiving position on the receiving means according to information out of the counting means.

### BRIEF DESCRIPTION OF THE DRAWINGS

FIG. 1 is a structural diagram showing an image forming apparatus and a sheet processing apparatus according to the first embodiment;

FIG. 2 is a cross section showing the sheet processing apparatus;

FIG. 3 is a structural diagram showing an alignment vertical path;

FIG. 4 is an illustration for removal of obliquely feeding in a front page path and registration alignment;

FIG. 5 is a diagram showing a pasting unit;

FIG. 6 is a diagram showing a mechanism for adhering a front page to a pasted sheet bundle; ]FIG. 7 is a diagram showing a buffer mechanism with the alignment vertical path;

FIG. 8(a) is a diagram showing a conveyance state of the sheet bundle from a pasting process to a rotation stage; FIG. 8(b) is a diagram showing a conveyance state of the sheet bundle from the rotation stage to a trimmer portion; FIG. 8(c) is a diagram showing a conveyance state of the sheet bundle from the rotation stage to a sheet bundle tray;

FIG. 9 is an illustration showing the rotation stage;

FIG. 10 is an illustration showing the trimmer unit;

FIG. 11 is an illustration showing a cutting means and a receiving means;

FIG. 12 is an illustration showing the cutting means and the receiving means;

FIG. 13 is an illustration showing a sheet bundle holding means;

FIG. 14 is an illustration showing a mechanism dropping dusts into a pusher by means of a mat rotation;

FIG. 15 is an illustration showing a controller for mat drive of the sheet processing apparatus;

FIG. 16 is a flowchart showing trimmer operation;

FIG. 17 is a flowchart showing mat rotation operation;

FIG. 18(a) and FIG. 18(b) are illustrations for receiving means in respective belt shapes according to other embodiments; and

FIG. 19(a) and FIG. 19(b) are illustrations for pushingly cutting method and shearing method as conventional sheet bundle cutting methods.

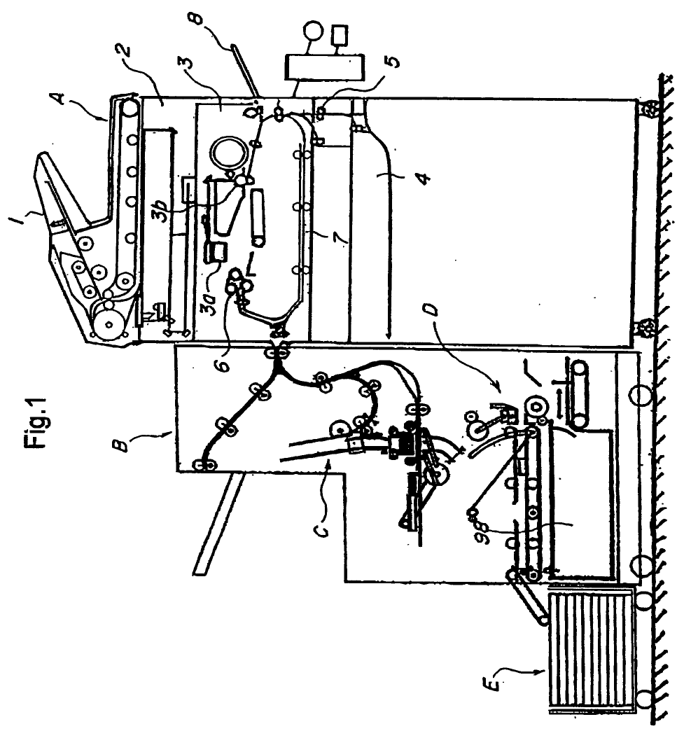

### DETAILED DESCRIPTION OF THE PREFERRED EMBODIMENTS

### First Embodiment

Referring to the drawings, a first embodiment of the sheet bundle apparatus according to the invention is described. A photocopier is structured in coupling an image forming apparatus body A and a sheet processing apparatus B. The sheet processing apparatus B has a function cutting after aligning, pasting, and binding sheets to which images are recorded at the image forming apparatus body A.

### The Whole Structure of the Image Forming Apparatus

The image forming apparatus body A optically reads with a scanner section 2 original documents automatically fed from an original document feeding apparatus 1 attached to a top of the apparatus, transmits the information as a digital signal to an image forming section 3 as an example of an image forming means, and records the information on recording sheets such as plain paper and OHP sheets.

Plural sheet cassettes 4 containing sheets in various sizes are attached below the image forming apparatus body A, and images are recorded in an electrophotographic method at the image forming section 3 with respect to sheets conveyed from the sheet cassettes 4 with a conveyance roller 5. That is, latent images are formed by radiation of laser beam to a photosensitive drum 3b out of a light emitter 3a based on the information read at the scanner section 2, are transferred to a sheet upon being developed with toner, and are permanently fixed upon conveyance to a fixing section 6 and application of heat and pressure.

In a case of the one side recording mode, the sheet is fed to the sheet processing apparatus B. In a case of the double side recording mode, the sheet is conveyed to a re-feeding path 7 via a switchback and is fed into the sheet processing apparatus B after formed with images on an one side upon conveying, again to the image forming section 3, the sheet on the other side of which images are recorded. A signal about paper size and the like is transmitted from the image forming apparatus body A to the sheet processing apparatus B before feeding the sheets, thereby performing switching of the paths in the sheet processing apparatus B in advance.

It is to be noted that sheet feeding can be done not only from the sheet cassettes 4 but also from a multi-tray 8.

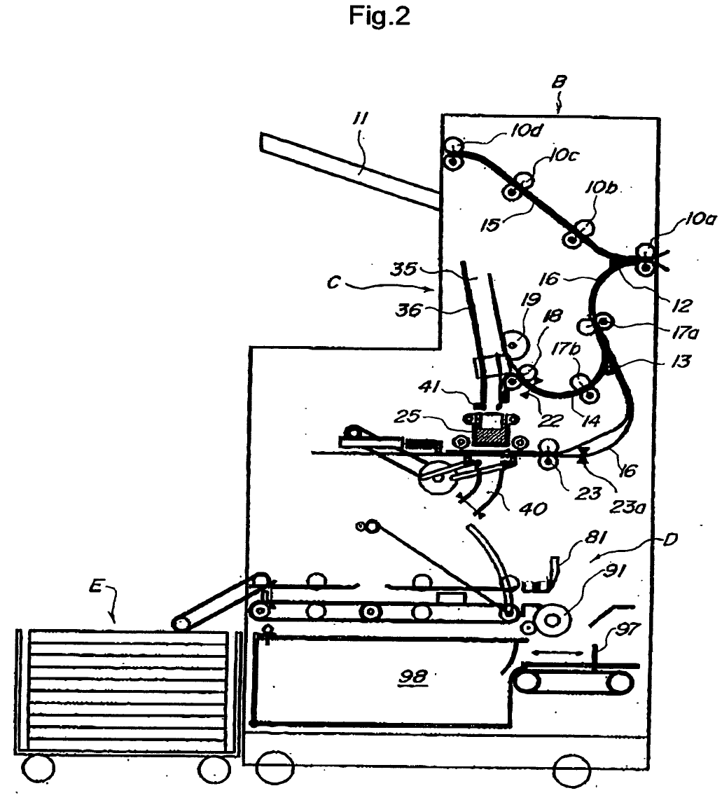

As shown in FIG. 2, the sheet processing apparatus B is structured of a conveyance alignment unit C and a trimmer unit D, and can selectively do bookbinding with pasting and cutting in addition to the normal delivery mode. Cutting, in the sheet processing apparatus B, can be made in three directions other than the pasting edge.

The sheets P delivered from the image forming apparatus body A to the sheet processing apparatus B according to the embodiment are conveyed with conveyance roller pairs 10a, 10b, 10c, 10d serving as examples of sheet conveying means during the normal mode, and is then delivered on a stacking tray 11. During the bookbinding with pasting mode, the sheets are delivered to a stacking tray E after processed with a prescribed treatment described below.

### Stacking on the Alignment Vertical Path

During the bookbinding mode, the sheet P delivered from the image forming apparatus body A is fed to a bookbinding intermediate paper path 14 by operation of a first flapper 12 and a second flapper 13. The first flapper 12 switches the path between a non-sorting path 15 and a top page path 16, and the second flapper 13 switches the path between the bookbinding intermediate paper path 14 and the top page 16.

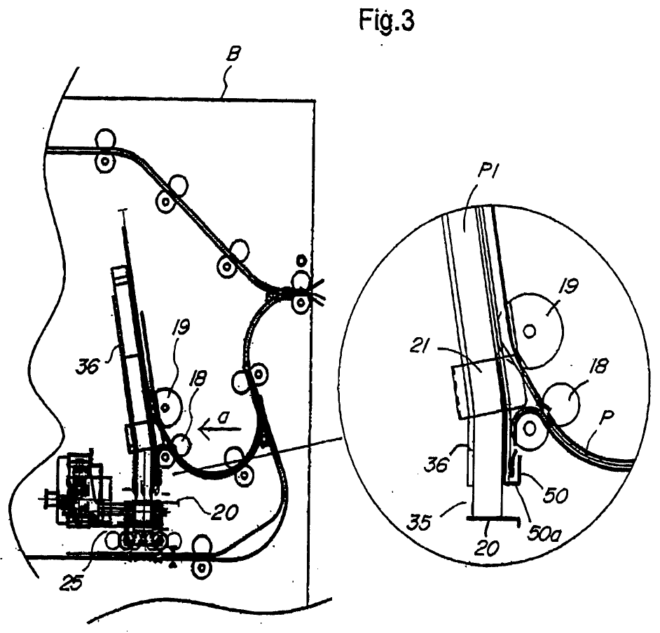

As shown in FIG. 3, the sheets P conveyed by the conveyance roller pairs 10a, 17a, 17b are aligned in a sheet conveyance direction by returning a rear end of the sheet P to a position contacting to a rear end stopper 20 in aid of a half moon roller 19 and a delivery roller pair 18 after delivered to the alignment vertical path 35 by the delivery roller pair 18. The sheet P is pushed in a direction of the sheet center by an alignment plate 21, so that the sheets P are aligned in a direction perpendicular to the sheet conveyance direction.

The rotation speed of the delivery roller pair 18 is controlled to be a low speed when the rear end of the sheet P passes through the delivery roller pair 18. This renders the sheet P delivered in the alignment vertical path 35 surely pulled into the roller by rotation of the half moon roller 19, thereby making the rear end alignment.

It is to be noted that whether the rear end of the sheet passes by the delivery roller pair 18 is judged in passing a prescribed period of time after the sheet P passes by the delivery sensor 22 or in detecting the rotation number of the motor.

### Half Moon Roller

Next, the half moon roller 19 for pulling back, in a direction reverse to the delivery direction, the sheet P delivered on the alignment vertical path 35, is described.

As shown in FIG. 3; the half moon roller 19 is in a shape of a half moon cut out, and the cutout portion of the half roller 19 is normally positioned on a side of the alignment vertical path 35, thereby not disturbing the delivery of the sheet P which is delivered by the delivery roller pair 18. The half moon roller 19 rotates in the reverse direction to the sheet delivery direction at each sheet delivery of the sheets P on the alignment vertical path 85, and pulls back the sheet P by frictional force produced between the sheet P and the roller 19 upon contacting to the rear end of the sheet P on the alignment vertical path 35.

### Alignment Vertical Path Plate

The alignment vertical path plate 36 is movable in a direction of arrow a set forth in FIG. 3 by an alignment vertical path motor, not shown, thereby adjusting a distance between the paths of the alignment vertical path 35. According to the sheet number of the sheet delivered on the alignment vertical path 35 to maintain contact pressure to the topmost sheet delivered onto the alignment vertical path 35 at approximately a constant amount with respect to the half moon roller 19, the alignment vertical path plate 36 is moved in a direction widening the path.

### Operation Timing of the Half Moon Roller

With respect to operation timing of the half moon roller 19, the roller 19 operates after the delivery roller pair 18 releases the rear end of the sheet P. More specifically, the half moon roller 19 rotates in a direction reverse to the sheet delivery direction after passing a predetermined period of time after the rear end of the sheet P passes by a delivery sensor 22 formed on an upstream side of the delivery roller pair -18.

### Top Page Path

The sheet P delivered from the image forming apparatus body A is fed to the top page path 16 in association with the first flapper 12 and the second flapper 13.

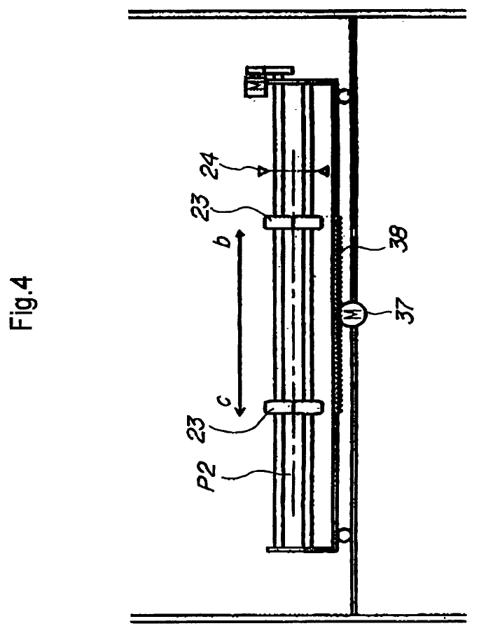

As shown in FIG. 2 and FIG. 4, a registration roller pair 23 is disposed at a midway of the top page path 16, and a registration front end sensor 23a is disposed on an upstream side of the registration roller pair 23. The registration roller pair 23 stops at a time when the top page sheet P2 is guided to the top page path 16, and begins rotating after a prescribed time passes after the front end of the top page sheet P2 comes in contact with the registration roller pair 23. Whether the front end of the top page sheet P2 contacts to the registration roller pair 23 can be judged by passing the prescribed period of time after the top page sheet P2 passes the registration front end sensor 23a or by detecting the motor rotation number.

With this control, a loop can be made at a front end of the top page sheet P2 guided to the top page path 16, and obliquely feeding of the top page sheet P2 can be corrected.

The registration roller pair 23 is movable in a direction perpendicular to the sheet conveyance direction with a rack 38 via a top page motor 87. The registration roller pair 23 moves in a direction of b in FIG. 4 as contacting with pressure to and conveying the top page sheet P2 after the rear end of the top page sheet P2 passes by the conveyance roller pair 17a, moves in a direction of c after the registration sensor 24 is shielded, and stops upon movement of a prescribed amount after the registration sensor 24 is released. Because the registration sensor 24 is disposed at a paper end position of the sheet bundle P1 in the alignment vertical path 35, the top page sheet P2 in the top page path 16 and the sheet bundle P1 in the alignment vertical path 35 are moved to a position shifted by a prescribed amount in a direction perpendicular to the sheet conveyance direction.

The registration roller pair 23 receives a paper size signal from the image forming apparatus body A and stops upon conveying the top page sheet P2 within the top page path 16 in a prescribed amount according to the paper size.

### Gripper

A gripper 41 is located below the alignment vertical path 35, grips the sheet bundle P1 stacked on the alignment vertical path 35, and has a function for guiding the bundle to the top page sheet P2.

### Pasting Unit

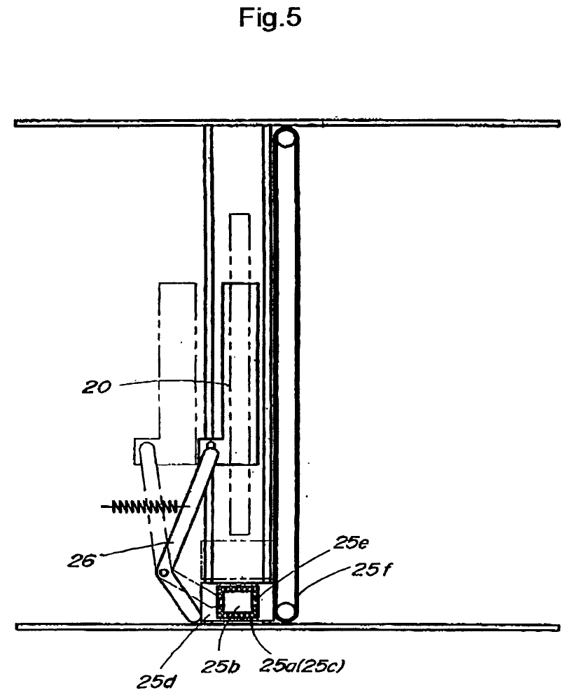

FIG. 5 shows a diagram of a pasting unit 25. As shown in FIG. 5, the pasting unit 25 is structured of a paste pot 25a, a pasting roller 25b, a paste 25c, a paste pot heater 25d, a shaft 25e, and a pot driver 25f The paste pot 25a is movable more than the sheet width in a sheet width direction perpendicular to the sheet conveyance direction along the shaft 25e, has escaping positions at two locations outside the sheet width, and moves in association with the pot driver 25f According to movement from the first escaping position to the second escaping position, a portion of the paste pot 25a pushes a part of a link 26 coupled to a rear end stopper 20, thereby moving the rear end stopper 20 in a direction escaping from a lower portion of the sheet bundle P1 in FIG. 3. The paste roller 25b is arranged at the paste pot 25a and rotates in synchrony with the movement of the paste pot 25a.

The pot heater 25d is attached to the exterior of the paste pot 25a, and the pot heater 25d heats the paste pot 25a at the beginning of the bookbinding mode, thereby melting the paste 25c in the paste pot 25a. The melted paste 25c reaches out the entire outer peripheral surface of the paste roller 25b because the paste roller 25b rotates in association with movement of the paste pot 25a driven by the pot driver 25f.

The sheet bundle P1 stacked in the alignment vertical path 35 is held with the gripper 41, and the paste 25c is coated on a lower end surface at the pasting unit 25 upon escaping the rear end stopper 20 from the lower portion of the sheet bundle P1 where the paste pot 25a moves from the first escaping position to the second escaping position

### Bookbinding Process

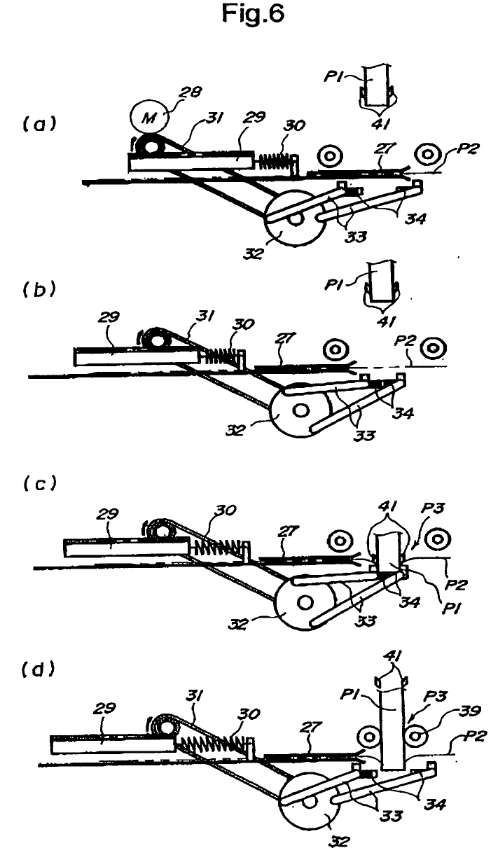

As shown in FIG. 6(a), a shutter path 27 is positioned on a downstream side of the top page path 16, and the shutter path is closed while the top page sheet P2 is conveyed.

During the bookbinding process the shutter motor 28 drives the shutter rack 29 as shown in FIG. 6(b), and a spring 30 engaging the shutter path 27 with the shutter rack 29 moves the shutter path 27 up to the opening position. After the shutter path 27 is opened, the shutter path 27 comes in contact with a stopper, not shown, so that the shutter path 27 stops.

After the paste 25c is coated on the sheet bundle P1 held at the gripper 41, the gripper 41 is moved as to render the sheet bundle P1 with paste come in contact with the top page sheet P2 on a folding line application table 34, thereby contacting the sheet bundle P1 with the top page sheet P2.

Subsequently, as shown in FIG. 6(c), when the shutter motor 28 is driven, a cam 32 driven with a belt 31 from the shutter motor 28 further rotates to make the folding line application table 34 slide in association with a guide shaft 33. Folding lines are given for a prescribed period of time with the folding line application table 34, thereby completing a bookbinding sheet P3.

It is to be noted that an escaping mechanism is formed at the folding line application table 34 as to correspond to changes of the paper thickness. Furthermore, as shown in FIG. 6(d), rotation of the cam 32 escapes the folding line application table 34, and the bookbinding sheet bundle P3 is pushed toward a downstream side with a pushing roller 39 and conveyed to a bundle curvature path 40.

### Buffer Mechanism

A buffer mechanism 50 temporarily escaping the sheets P conveyed from the image forming apparatus body A during the sheet postprocessing period such as bookbinding with pasting or the like, is described.

The buffer mechanism 50 has a structure movable in the same direction to as well as in a direction perpendicular to the sheet conveyance direction as shown in FIG. 3 and FIG. 7. Where the buffer mechanism 50 moves in the same direction to the conveyance direction, an electromagnetic clutch gear 50c only is operated to transmit the motor's drive, and the buffer mechanism 50 is moved upon transmitting the drive to a rack 50e via a gear 50d.

At that time, utilizing a photo sensor 50f and a protrusion formed at one end of the buffer mechanism 50 for shielding the photo sensor, a position and an amount of movement in the same direction to the conveyance direction of the buffer mechanism 50 are controlled.

When movement is made in a direction perpendicular to the conveyance direction, a current is sent to only the electromagnetic clutch gear 50g thereby rendering the drive of motor transmit. The drive is transmitted to the rack 50b via the gear 50h, thereby moving a reception table 50a.

At that time, utilizing a photo sensor 50i and a protrusion formed at one end of the rack 50b for shielding the photo sensor, a position and an amount of movement in a direction perpendicular to the conveyance direction of the reception table 50a of the buffer mechanism 50 are controlled.

The reception table 50a of the buffer mechanism 50 escapes outside of the width of the sheet P in FIG. 7 except a situation that the sheet P has to be buffered, so that the table 50a will not disturb the sheet conveyance.

The basic operation of the buffer mechanism 50 is described. First, as shown in FIG. 3, a sheet bundle P1 stacked and aligned at the alignment vertical path 35, and it is assumed that the sheet bundle is not yet delivered from the alignment vertical path 85. At that time, the reception table 50a is moved in a sliding manner to a position receiving the sheet P shown in FIG. 7 from the escaping position so as not to disturb the conveyance of the sheet P to buffer the sheet P successively conveyed from the image forming apparatus body A.

Where the sheet bundle P1 is delivered from the alignment vertical path 35, the buffer mechanism 50 is moved in the same direction to the conveyance direction, or namely in a direction toward the rear end stopper 20 shown in FIG. 7. When the rear end of the buffered sheet P is supported to the rear end stopper 20, the movement is stopped, and the reception table 50a is moved to an escaping position. Finally, the buffer mechanism 50 is returned in a direction reverse to the rear end stopper 20 and moves to the initial escaping position (home position) to end the operation. The above operation is repeated until completion of the targeted number of the booking binding process.

### Rotary Stage

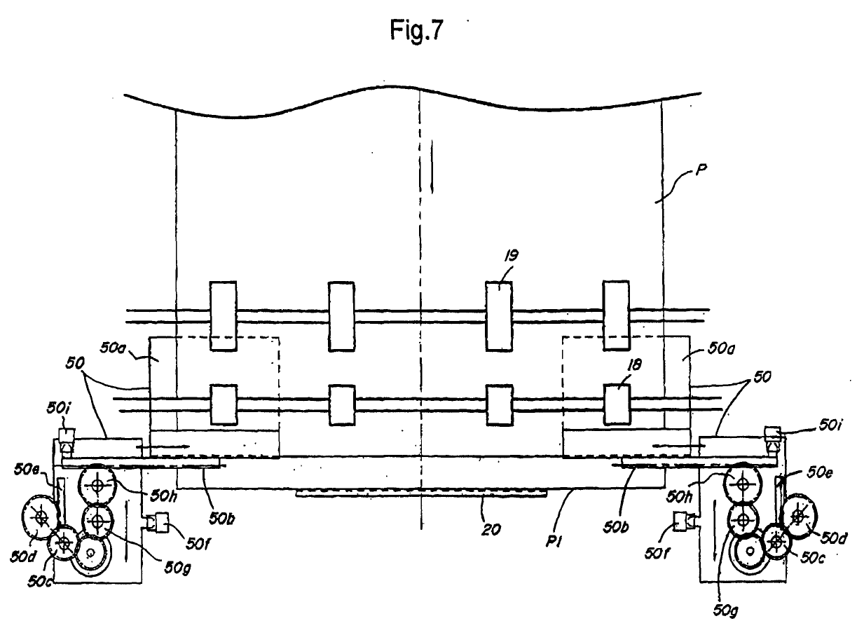

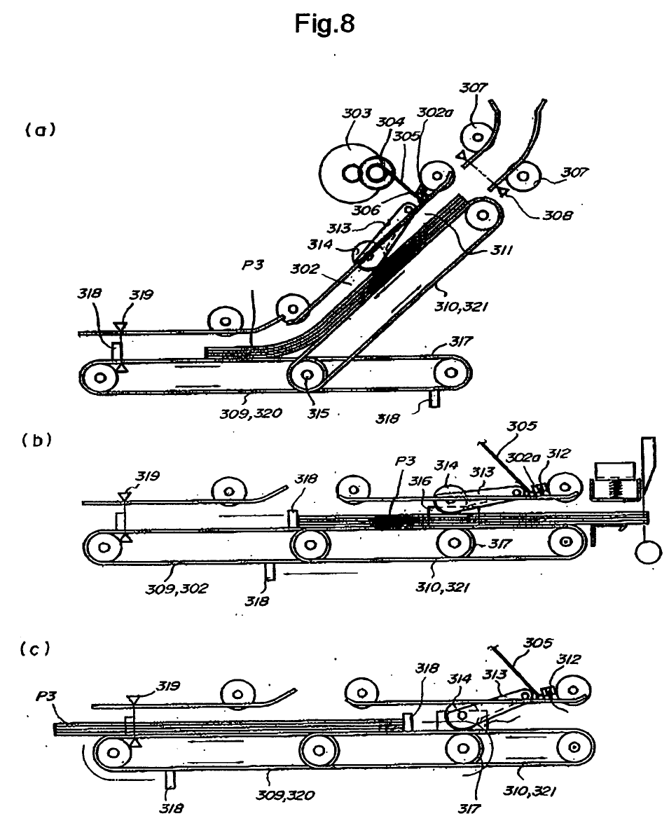

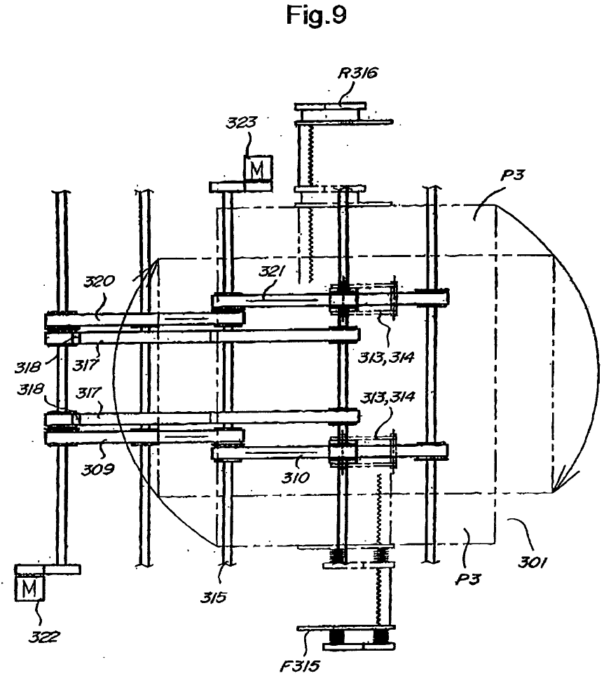

Referring to FIG. 8, FIG. 9, a rotary stage 301 for rotating the bookbinding sheet bundle P3 that has been subject to bookbinding and for conveying the bundle in the trimmer unit D.

As shown in FIG. 8(a), a bundle conveyance unit 302 rotates around a rotary shaft 315 as a center upon winding a wire 305. The wire 305 is secured to an up down gear driven with an up down motor 303. When a sensor 306 detects a protrusion 302a on the bundle conveyance unit 302, the up down motor 303 is stopped to render the bundle conveyance unit 302 wait at a position in FIG. 8(a).

The bookbinding sheet bundle P3 bookbinded at the bookbinding step is conveyed with a bundle conveyance roller pair 307. A first conveyance belt 309, a second conveyance belt 310, a third conveyance belt 320, and a fourth conveyance belt 321 are driven with a conveyance belt motor F322 and a conveyance belt motor R323 at a ting that the front end of the bookbinding sheet bundle P3 is detected with a sensor 308 and rotate in the arrow direction.

The bookbinding sheet bundle P3 is conveyed in a conveyance path 311 of the bundle conveyance unit 302 with the bundle conveyance roller pair 307. The up down motor 303 rotates reverse at a time that the rear end of the bookbinding sheet bundle P3 passes by the sensor 308 to render the bundle conveyance unit 302 move to the position in FIG. 8(b). When a sensor 312 detects the protrusion 302a on the bundle conveyance unit 302, the drive of the up down motor 303, the conveyance belt motor F322, and the conveyance belt motor R323 is stopped, thereby rendering the bookbinding sheet bundle P3 wait in a state as nipped between the conveyance belts 310, 321 and a weight roller 314 located at a weight 313.

The bookbinding sheet bundle P3 is aligned with alignment plates F315, R316 driven with a motor, not shown, at this timing and is positioned on the side of the alignment plate R316. Because the bookbinding sheet bundle P3 at that time is bookbinded as the top page is shifted when this bookbinding is made with the alignment vertical path 35 and the top page path 16, the edge of the bookbinding sheet bundle P3 can be positioned with a high accuracy on the side of the alignment plate R316 when aligned with the alignment plates. Where the motor, not shown, drives the timing belt 317 at the same time, a hitting plate 818 moves up to a designated position from the position of the sensor 319, thereby conveying the bookbinding sheet bundle P3 in the trimmer unit D. At that time, the bookbinding sheet bundle P3 is conveyed as three edges are restricted by the alignment plates F315, R316 and the hitting plate, thereby improving the conveyance accuracy up to the trimmer portion.

When cutting starts at the trimmer unit D, the alignment plates F315, R316 and the hitting plate 318 move to the home position and wait. When cutting completes, the conveyance belts 309,310, 320, 821 rotate in the counterclockwise direction to convey the bookbinding sheet bundle P3 nipped with the weight roller 314 to a place at which the weight roller 314 is located near the center of the bookbinding sheet bundle P3, and the conveyance belts 309,310, 320, 321 stop at that position.

Thereafter, the conveyance belts 309, 310 and the conveyance belts 320, 321 rotate the in a direction opposite to each other as shown in FIG. 9, thereby rotating 90 degrees the bookbinding sheet bundle P3 around the weight roller 314 as a center. After rotation of 90 degrees, the conveyance belts 309, 310, 320, 321 are stopped, and the bookbinding sheet bundle P3 is aligned again by the alignment plates F315, R316 and the hitting plate, is conveyed to the prescribed position in the trimmer unit D, and is subject to cutting.

After the bookbinding sheet bundle P3 is then conveyed to the weight, roller 314 in the same operation, the bundle is rotated by 180 degrees to be loaded again in the trimmer unit D and to be cut. The bookbinding sheet bundle P3 after completion of cutting is conveyed to the weight roller 314, and after rotated by 90 degrees, the bookbinding sheet bundle P3 is conveyed to the stacking tray E upon rotating the conveyance belts 309, 310, 320, 321 in an arrow direction in FIG. 8(c). At the same time, the rear end of the bookbinding sheet bundle P3 being conveyed is operated as to be pushed out by rotating a hitting plate 318 in one turn in the arrow direction, thereby delivering the bookbinding sheet bundle P3 surely on the stacking tray E.

### Trimmer Structure

Referring to FIG. 2 and FIGS. 10 to 13, a structure of the timer unit D is described. The trimmer unit D is aiming to finish the sheet bundles with high quality and makes cutting at three edges of the sheet bundles bookbinded with pasting except the edge with pasting ill use of the pasting unit 25.

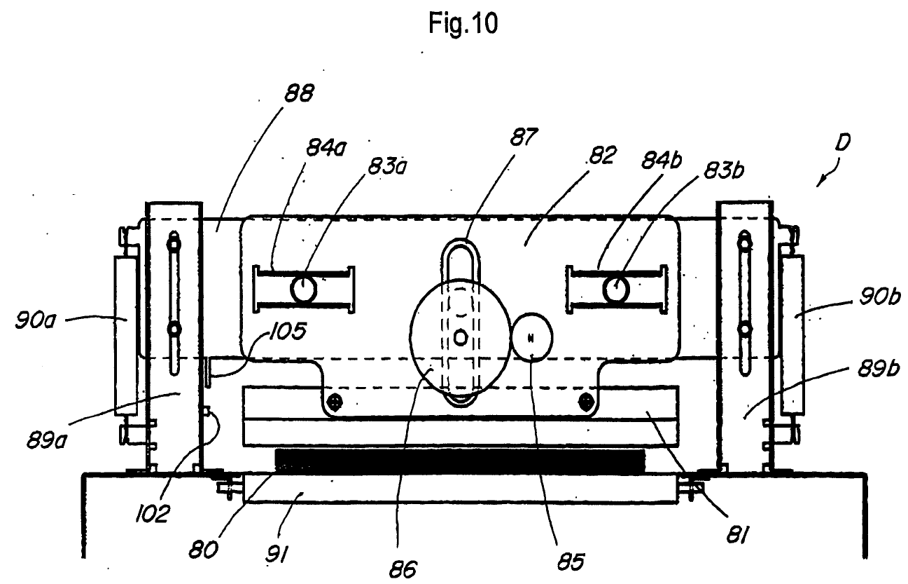

FIG. 10 is a diagram showing the trimmer unit D. A cutting blade 81 is formed as an example of a cutting means for cutting the bookbinding sheet bundle P3. As shown in FIG. 11(a), FIG. 11(b), the shape of the cutting blade 81 is in a plate shape or a disc shape, and the blade has an inclined face on one side only.

Where the cutting blade 81 is in a plate shape, the cutting blade 81 performs cutting as moving reciprocally parallel with respect to the cutting surface. It is like as a similar motion a motion of cutting wood with a saw. Because the cutting blade 81 necessarily rides always on the bookbinding sheet bundle P3 even while moving thus, the longitudinal direction is required to be longer than the maximum sheet size. For example, if the maximum sheet size is in the longitudinal direction of A4 size, the length is needed more than 297 mm plus the moving distance of the cutting blade 81.

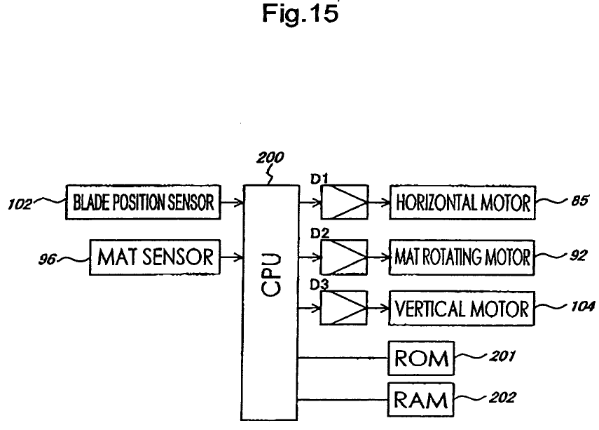

The cutting blade 81 is secured to a longitudinal direction moving member 82 capable of sliding only parallel to the cutting face of the bookbinding sheet bundle P3. The longitudinal direction moving member 82 is supported to rollers 83a, 88b, and the rollers 83a, 83b move only parallel with respect to the cutting face in the longitudinal direction along hitting portions 84a, 84b of the longitudinal direction moving member 82. The parallel movement in the longitudinal direction is done by a horizontal motor 85, and drive is transmitted to a rotation receiver 87 via a rotary cam 86 to render the longitudinal direction moving member 82 move reciprocally. The speed of the reciprocal movement can be changed freely by equipping an encoder at the horizontal motor 85. The encoder counts up the number of the reciprocal movement in the longitudinal direction, and the information is submitted to a CPU 200 in FIG. 15, thereby informing the user of the replacement period of the cutting blade 81 upon comparative execution of the information and the prescribed number stored in the CPU 200 in advance.

The movement of the cutting blade 81in the thickness direction of the bookbinding sheet bundle P3 is done by a vertical movement member 88, and where posts 89a, 89b coupling to a housing are provided at each end of the bookbinding sheet bundle P3, the cutting blade 81 moves in a vertical direction along grooves of the posts 89a, 89b. Because the vertical movement member 88 has the rollers 83a, 83b supporting the longitudinal direction moving member 82, the cutting blade 81 moves in the vertical direction according to the vertical movement of the longitudinal direction moving member 82. Pulling spring 90a, 90b are formed at the vertical movement member 88 to apply a load to the cutting blade 81. The cutting blade 81 is structured as to always receive the load in the thickness direction of the bookbinding sheet bundle P3 by the pulling springs 90a, 90b through the vertical movement member 88 and to move downward.

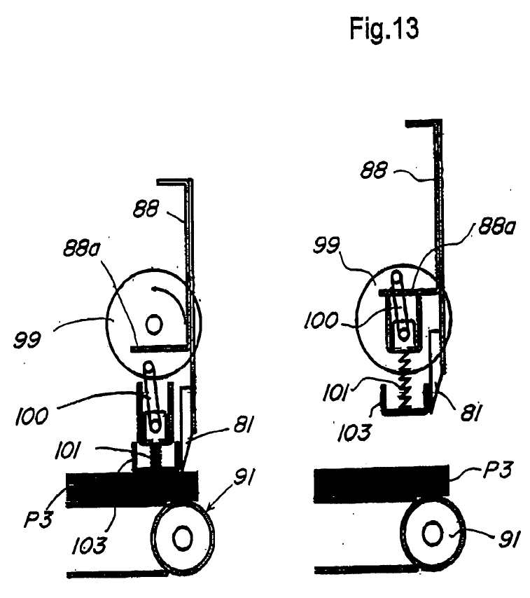

Furthermore, as shown in FIG. 13, a sheet pusher 103 pushes the bookbinding sheet bundle P3 as contracting a paper pushing spring 101 upon movement of a linkage 100 to a lower pivotal center position according to rotation of a cam 99 by the drive of a vertical motor 104 (see, FIG. 15). An attachment member of the linkage 100 is separated from a contacting member 88a of the vertical movement member 88, and the cutting blade 81 pushes and cuts the bookbinding sheet bundle P3 by the pulling springs 90a, 90b via the vertical movement member 88. This mechanism also serves as a mechanism lifting up the cutting blade 81. The attachment member of the linkage 100 hits the contacting portion 88a of the vertical movement member 88 when the cam 99 rotates to move the linkage 100 up to the upper pivotal center position and to disengage the sheet pusher 103, thereby rendering the cutting blade 81 move upward in the thickness direction of the bookbinding sheet bundle P3 via the vertical movement member 88. Those mechanisms allow the cutting blade 81 up and down reciprocall movable in the thickness direction.

As shown in FIG. 10, a blade position sensor flag 105 is provided at the vertical movement member 88, and a blade position sensor 102 is arranged at a post 89a to detect the flag. Cutting of the bookbinding sheet bundle P3 done by the cutting blade 81 is performed until that the blade position sensor flag 105 detects the blade position sensor 102. Counting of the cutting times is done by counting up the detection signal from the blade position sensor 102.

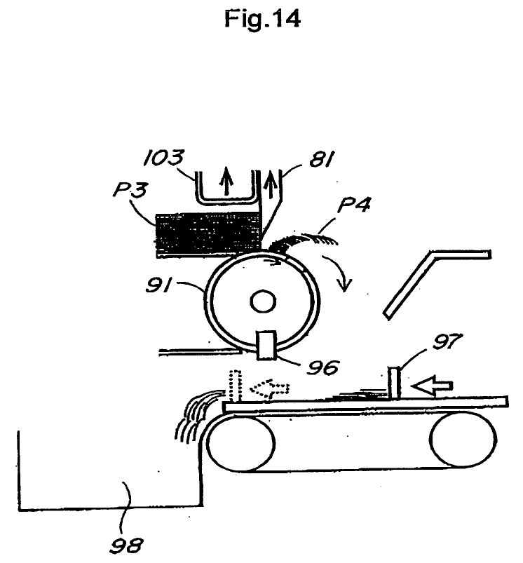

A mat 91 as an example of a receiving means for the cutting blade 81 is arranged at a lower portion of the bookbinding sheet bundle P3 to prevent, the cutting blade 81 from receiving damages. The material of the mat 91 is preferably of a soft material, such as rubber, molded materials, or urethane. The shape of the mat 91 in this embodiment is in a roller shape having a cross section in a circular shape, and the mat 91 is rotatable in an arrow direction shown in FIG. 14 in association with rotation of a mat rotation motor 92 described below.

With such a structure of the mat 91, a gap to the roller surface can be maintained at a fixed amount with a scraping member or the like, so that cutting dusts attached to the surface can be scraped off easily. That is, if the roller is in a rectangular shape as in the conventional example, the gap between the scraping member and the rectangular roller may be deviated larger or smaller when the roller is rotated at the position as in this embodiment, so that there raises a problem that dusts attached to the surface may not be scraped off effectively. Where the mat 91 is rotated, the cutting dusts P4 after cutting can be dropped upon moved to a dust box 98 as an example of a storing means.

The mat 91 in a roller shape is structured so that a rubber layer is formed with pressure or with a thermal treatment on a surface of a metal shaft or a metal pipe shaft. This structure brings a rigidity to some extent to the roller-shaped mat 91 itself, so that the cut position is not bent even where receiving the pushing force from the cutting blade 81 during cutting of the bookbinding sheet bundle P3.

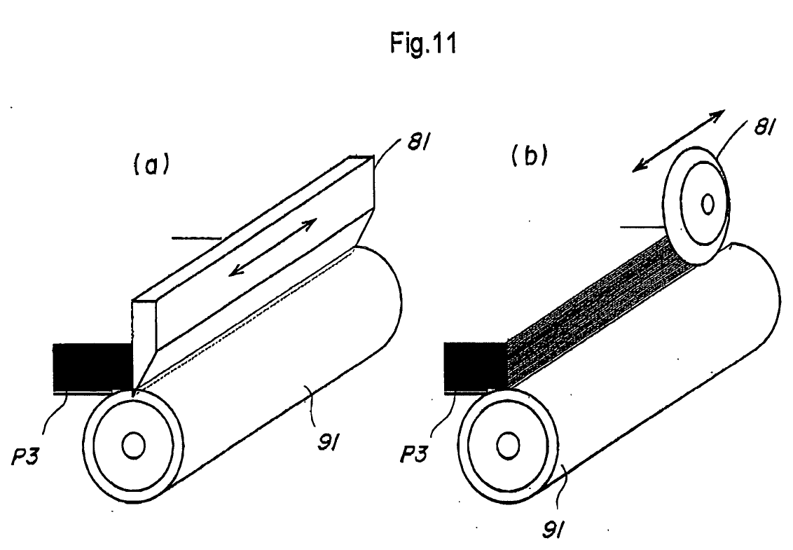

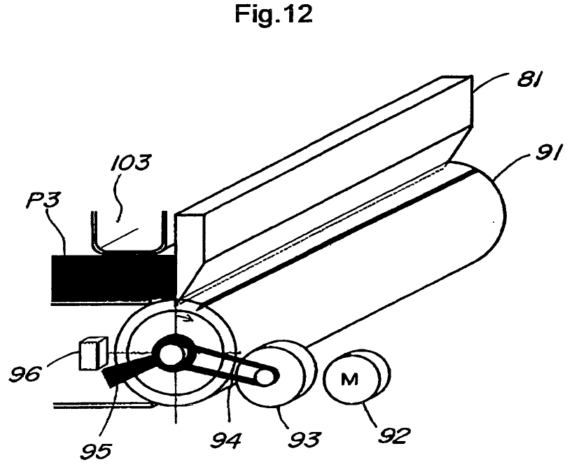

As shown in FIG. 12, before any groove is formed on the mat 91 by the cutting operation, the bookbinding sheet bundle P3 is cut upon moving a blade receiving position to a new region at which no groove is formed by rotatively moving the receiving position of the cutting blade 81 at each cutting operation. This makes the durability of the mat 91 extended, thereby avoiding troubles from occurring such that some groove is formed on the mat 91 due to contacts between the mat 91 and the cutting blade 81 at =any times to render the cutting face of the lowermost sheet of the sheet bundle (or namely a sheet directly contacting to the mat 91) rough or to render the sheet bundle cut completely.

The mat 91 experimentally has durability against cutting of 200 to 300 times at a position. Therefore; with the mat 91, cutting of 300 times can be done at a position. The mat 91 slightly moves rotatively by a prescribed amount (e.g., 5 degrees in this embodiment) to shift the blade reception position during the cutting operation after the dust treatment operation. Accordingly, the mat 91 can be used for cutting at 72 portions as 360 degrees divided by 5 degrees, where durable against 300-time cutting per one position, so that the mat 91 can have durability against 21600 time cutting as cutting of 72 positions for one turn of the mat multiplied by 300 times at one position.

Although in this embodiment the blade reception position is controlled to rotatively move at each cutting, control is possible such that the blade reception position may be the same until reaching 300 times of cutting and that the mat 91 rotatively moves by five degrees upon 300 time cutting. Although in this embodiment the rotational moving amount of the mat 91 is set as 5 degrees, the amount is not limited to five degrees according to the shape or the like of the mat 91 and can be set freely as to move a slight amount.

As an example of a cutting blade receiving position moving means, drive force is transmitted from a mat rotary motor 92 via a gear 93 and a drive belt 94, thereby rotatively moving the mat 91. The rotary moving amount of the mat 91 is controlled by controlling the mat rotation motor 92 where the CPU as described below receives information from a mat sensor flag 95 and a mat sensor 96 serving as a moving amount detecting means The information about the cutting times and the cutting position is memorized in the CPU 200. Even where the power supply of the image forming apparatus is cut off, the cutting operation begins at the next cutting at a position proceeded by a prescribed amount (or 5 degrees in this embodiment) from the receiving position at the time of power-off. The cutting time is counted up, and the information thereof is sent to the CPU 200, so that the replacement period can be informed to the user at a time reaching the duration times of the mat 91 upon comparative execution of the information above and the prescribed times memorized in the CPU 200 in advance. Otherwise, the CPU can detect the cutting position on the mat 91(the moving amount detecting means) according to information from the mat sensor 96, and the replacement period can be informed to the user, for example, when the cutting position carries out on the mat 91 for one round.

The mat 91 after completion of the cutting operation is rotated to remove the cutting sheet dusts P4 on the mat 91, thereby dropping the cutting sheet dusts P4 in the dust box 98. For example, the mat 91 is rotated twice with the mat rotation motor 92 to drop the cutting sheet dusts P4. After twice rotated, the mat 91 waits at a reception position proceeding from the previous cutting position by the prescribed amount (or 5 degrees in this embodiment) for preparing the subsequent cutting operation. The cutting dusts P4 dropped from the mat 91 are dropped in front of the pusher 97 according to the rotation of the mat 91 as shown in FIG. 14 and are conveyed to the dust box 98 with the pusher 97 movable by a motor not shown.

### Structure of the Controller Regarding Mat Rotation Drive in the Sheet Processing Apparatus

Now, referring to FIG. 15, the structure of the controller regarding the drive of the mat 91 according to this embodiment is described briefly.

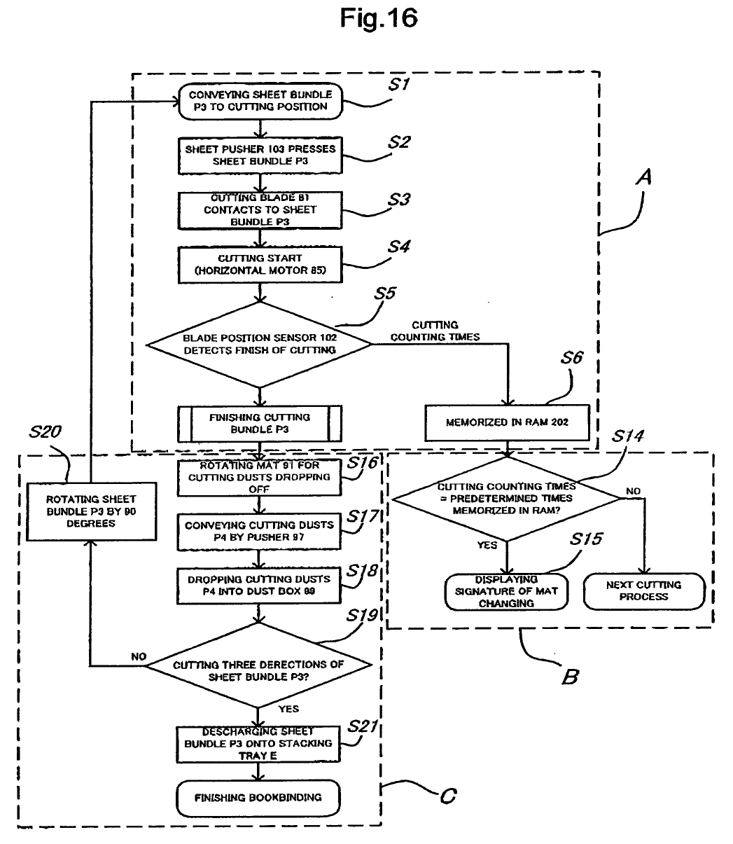

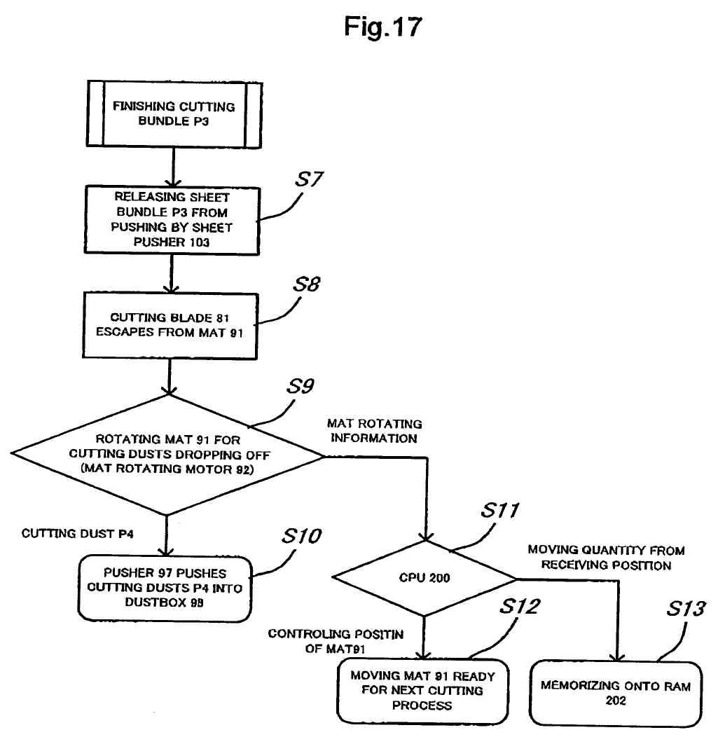

In FIG. 15, as a controlling means, numeral 200 is a central processing unit (CPU) performing controlling i-a executing programs memorized in ROM. Numeral 201 is a read only memory (ROAD storing a control program for controlling the sheet processing apparatus B, which serves for control programs corresponding to control steps shown in FIG. 16 and FIG. 17 and control steps for other portions. Numeral 202 is a random access memory (RAM) for storing operation data used for execution of the above control programs in the CPU 200, control data sent from the image forming apparatus body A, count data about cutting times as described below, various work data, and input data. The CPU 200 executes the control programs based on the control data sent from the image forming apparatus body A and the control programs stored in the ROM 201 in association with various data or the like in the RAM 202, as well as based on the information from the various sensors electrically coupled thereto, thereby controlling drives of the various motors and the entire sheet processing apparatus B, and performing telecommunications with the sheet processing apparatus B and the image forming apparatus body A.

The CPU 200 inputs signals from the blade position sensor 102 used for count signals of cutting completion detection and cutting times, the mat sensor 96 used for the rotation amount of the mat 91 and controlling of the blade receiving position movement, and the like.

The movement amount and the speed of the horizontal motor 85, the mat rotation motor 92, the vertical motor 104, and the like are controlled by control input pulses and encoder inputs detecting the rotation amount via the respective drivers D1, D2, D3 based on the signals.

### Operation of the Trimmer

With the trimmer and the controller thus constituted, in reference to a flowchart shown in FIG. 16 from the conveyance of the bookbinding sheet bundle P3 to the dust processing and a flowchart shown in FIG. 17 relating to the rotation of the mat 91, the operation of the trimmer unit D and the operation of this embodiment are described.

As shown in FIG. 16A, the CPU 200 controls to drive the conveyance belt motor F322 and the conveyance belt motor R322 based on such as paper size and set trimming width information from the image forming apparatus body A, thereby conveying the bookbinding sheet bundle P3 located on the rotary state 301 and conveying the sheet bundle up to the prescribe cutting position (S1). The trimming width of the bookbinding sheet bundle P3 at that time is about, e.g., 2 to 20 mm.

After the bookbinding sheet bundle P3 is conveyed, the CPU 200 drives the vertical motor 104 and controls rotatively the cam 99 until that the linkage 100 reaches the lower pivotal center position. The linkage 100 contracts the paper pushing spring 101 and concurrently pushes the bookbinding sheet bundle P3 with the sheet pusher 103 (S2). The cutting blade 81 via the vertical movement member 88 also moves according to the movement of the linkage 100 together with the sheet pusher 103 at that time, so that the cutting blade 81 contacts to a surface of the bookbinding sheet bundle P3 (S3).

After completion of pushing the bookbinding sheet bundle P3, the CPU 200 drives the horizontal motor 85 to move reciprocally the cutting blade 81 in the vertical direction with respect to the sheet bundle thickness direction via the rotary cam 86 and the longitudinal direction movement member 82. In association with the reciprocal movement, cutting the bookbinding sheet bundle P3 starts (S4), and the cutting blade 81 is pulled by the pulling springs 90a, 90b and moves in the thickness direction of the bookbinding sheet bundle P3 while cutting the bookbinding sheet bundle P3. Cutting operation done by reciprocal movement of the cutting blade 81 continues until the detection of the blade position sensor 102 by the blade position sensor flag 105 (S5).

The signal of cutting completion of the blade position sensor 102 by the blade position sensor flag 105 is sent to the CPU 200, and is memorized in the RAM 202 as the sheet cutting times as described below (S6)

As shown in FIG. 17, after completion of cutting the bookbinding sheet bundle P3, the CPU 200 drives the vertical motor 104 again, controls to rotate the cam 99 until that the linkage 100 reaches the upper pivotal center position, disengages the sheet pusher 103 (S7), and renders the cutting blade 81 escape from the mat 91 at the same time (S8). Cutting sheet dusts P4 may be dropped in the dust box 98 and may be remaining on the mat 91. As a processing operation for the cutting sheet dusts P4, as shown in FIG. 14, the CPU 200 drives the mat 92 to rotate the mat 91 twice (S9), thereby compulsively dropping the cutting dusts P4 in front of the pusher 97 without remaining the cutting sheet dusts P4 on the mat 91 (S10). Although in this embodiment the rotary amount to drop off the cutting sheet dusts P4 is twice, the rotation amount can be set arbitrarily because the CPU 200 can control upon detecting the rotation amount with the mat sensor 96 described below.

The rotation amount information of the mat 91 thus rotated by the mat rotation motor 92, the gear 93, and the drive belt 94 is sent to the CPU 200 upon detection by the mat sensor flag 95 and the mat sensor 96 (S11). The CPU 200 controls to drive the mat rotation motor 92 based on the information, controls to return the mat 91 to the original receiving position after rotating, e.g., twice the mat 91 as describe above to drop off cutting sheet dusts P4, and then controls the mat 91 to wait at the position slightly moved rotatively by the prescribed amount (five degrees in this embodiment) to move the receiving position of the cutting blade 81 as a preparation for the subsequent cutting (S12). Accumulation of the movement mount of the mat 91 slightly rotatively moved in the prescribed amount (five degrees in this embodiment) from the receiving position of the cutting blade 81 is memorized in the RAM 202 in the CPU 200 (S13). It is to be noted that because the information regarding the receiving position of the cutting blade 81 is memorized in the RAM 202 even where the power supply for the image forming apparatus is cut of, the mat 91 can wait so as to receive the cutting blade 81 at the subsequent cutting position based on the information when the image forming apparatus is turned on again.

As shown in FIG. 16B, the CPU 200 comparatively executes the cutting time memorized in a manner of a counter value in the RAM 202 inside the CPU 200 with the prescribed times memorized in the ROM 201 inside the CPU according to the detection signal of the blade position sensor 102 as described above, and sends a replacement sign of the mat 91 to the CPU of the image forming apparatus if the counted cutting number reaches the durable time of the mat 91 (S14). The CPU 200 can inform the user of the replacement period of the mat 91 by displaying at a display of the sheet processing apparatus or the image forming apparatus or by informing with voice or the like (S15).

Although in this embodiment the replacement sign of the mat 91 is generated upon comparison with the cutting number, the apparatus can be so controlled that the replacement sign of the mat 91 is provided based on comparative execution of the mat movement amount from the receiving position of the cutting blade 81 of the mat 91 with the prescribed value memorized in the ROM 201 in advance. For example, with a control that the receiving position is moved slightly rotatively to repeat the cutting operation at the subsequent position where a prescribed number of cutting is made at a cutting receiving position and where the cutting number reaches the cutting number permissive at the same cutting receiving position, it is enough and effective to comparatively execute the accumulation of the movement amount.

In this embodiment, the CPU 200 controls as described above where disposed in the sheet processing apparatus, but can be disposed in the sheet cutting apparatus or the image forming apparatus and can make control directly as described above.

As shown in FIG. 16C, the cutting dusts P4 dropped off from the surface of the mat 91 by the rotation of the mat 91 (S16) are conveyed by the pusher 97 (S17), and then dropped off in the dust box 98 (S18). After the rotary operation for the dust processing of the mat 91, the CPU 200 judges the cutting direction of the bookbinding sheet bundle P3 based on the sheet bundle cutting times memorized in the RAM 202, and if three directions of the bookbinding sheet bundle P3 are not cut (No at S19), the CPU sends the sheet bundle to the rotary stage 301 as described above to rotate the bookbinding sheet bundle P3 by 90 degrees. (S20) and to return the operation to S1. If the CPU 200 judges that three directions of the bookbinding sheet bundle P3 are cut (Yes at S19) as described above, the bookbinding sheet bundle P3 is delivered to the stacking tray E by the rotary stage 301 (S21).

### Other Embodiments

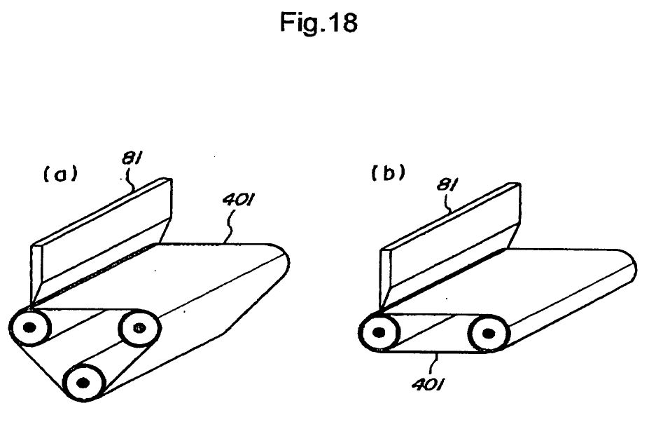

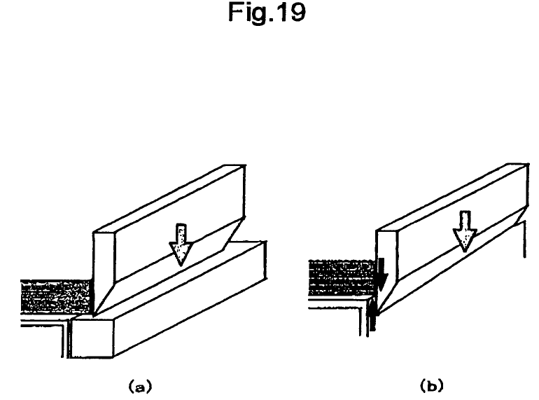

With reference to FIGS. 18 (a), (b), other embodiments of the sheet processing apparatus according to the invention are described. Portions overlapping as descriptions in the first embodiment are omitted upon assigning the same reference numbers.

In this embodiment, as a receiving means as shown in FIG. 18(a), 18(b), in lieu of the mat 91 exemplified in the first embodiment, a rotary belt 401 in a belt shape made of an elastic body is provided with this belt, the area of the receiving portion of the cutting blade 81 is widened, and the receiving position can be used widely by a length portion of the rotary belt 401 by driving the rotary belt 401, so that the durability of the rotary belt 401 can be improved.

what is claimed is:

1. A sheet cutting apparatus comprising:
cutting means for cutting a sheet bundle;
receiving means for receiving the cutting means;
receiving position moving means for moving a receiving position on the receiving means for receiving the cutting means; and
counting means for counting a number of cutting times of the sheet bundles,
wherein the receiving position moving means moves the receiving position on the receiving means according to information out of the counting means.

2. The sheet cutting apparatus according to claim 1, wherein the counting mean counts up the number of the cutting times of the sheet bundles by counting up a number of moving times of movement of the cutting means in a sheet thickness direction.

3. The sheet cutting apparatus according to claim 1, wherein information is given when judgment is made as that the receiving means reaches a replacement period according to information from the counting means.

4. The sheet cutting apparatus according to claim 1, and further comprising detecting means for detecting a moving amount of the receiving means, wherein information is given when judgment is made as that the receiving means reaches a replacement period according to a signal from the detecting means.

5. The sheet cutting apparatus according to claim 1, wherein the receiving means is rotatable and in a roller shape.

6. The sheet cutting apparatus according to claim 1, wherein the receiving means is rotatable and in a belt shape.

7. The sheet cutting apparatus according to claim 1, and further comprising storing means for storing cut sheet dusts, wherein a cut sheet dust processing in which cut sheet dusts are moved into the storing means is performed by moving the receiving means in association with the receiving position moving means.

8. The sheet cutting apparatus according to claim 7, wherein the cut sheet dust processing is defined as to rotate the receiving means in prescribed amount by the receiving position moving means, and wherein the movement of the receiving means is defined as to rotate the receiving means in a very small amount by the receiving position moving means.

9. The sheet cutting apparatus according to claim 1, wherein the cutting means is in a plate shape.

10. The sheet cutting apparatus according to claim 1, wherein the cutting means is in a disc shape.

11. A sheet processing apparatus comprising:
conveying means for conveying a sheet;
aligning means for aligning a plurality of the sheets; and
a sheet cutting apparatus as set forth in any of claim 1 to claim 10.

12. An image forming apparatus comprising:
conveying means for conveying a sheet;
image forming means for forming an image on the sheet; and
a sheet cutting apparatus as set forth in any of claim 1 to claim 10.

13. An image forming apparatus comprising:
conveying means for conveying a sheet;
image forming means for forming an image on the sheet; and
cutting means for cutting a sheet bundle;
receiving means for receiving the cutting means;
receiving position moving means for moving a receiving position on the receiving means for receiving the cutting means; and
counting means for counting a number of cutting times of the sheet bundles,
wherein the receiving position moving means moves the receiving position on the receiving means according to information out of the counting means.
